(19) United States
(12) Patent Application Publication
(10) Pub. No.: US 2019/0291579 A1
(43) Pub. Date: Sep. 26, 2019

(54) PROJECTION DISPLAY DEVICE, METHOD FOR CONTROLLING PROJECTION DISPLAY DEVICE, AND PROGRAM FOR CONTROLLING PROJECTION DISPLAY DEVICE

(71) Applicant: FUJIFILM Corporation, Tokyo (JP)

(72) Inventor: Koudai FUJITA, Saitama (JP)

(73) Assignee: FUJIFILM Corporation, Tokyo (JP)

(21) Appl. No.: 16/423,044

(22) Filed: May 27, 2019

Related U.S. Application Data
(63) Continuation of application No. PCT/JP2017/036252, filed on Oct. 5, 2017.

(30) Foreign Application Priority Data
Dec. 14, 2016 (JP) 2016-242628

(51) Int. Cl. B60K 35/00; G02B 27/01; E02F 9/26

(52) U.S. Cl. CPC B60K 35/00; G02B 27/0101; G02B 27/0179; E02F 9/26; B60K 2370/52; B60K 2370/31; B60K 2370/349; B60K 2370/1529; B60K 2370/334; G02B 2027/0141

(57) ABSTRACT

An HUD to be built in a construction machine includes an overlapping area detecting unit that detects a first overlapping area of a projection area and a bucket observed from a driver's seat; and a display control unit. In a state where a distance between a second overlapping area and the first overlapping area exceeds a threshold, the second overlapping area being an overlapping area of the projection area and a structure observed from the driver's seat, the display control unit performs tracking control in which a projection display unit is caused to display a virtual image based on operation support information while retaining a predetermined positional relationship with the first overlapping area. In a state where the distance is less than or equal to the threshold, the display control unit selects and performs either first control or the tracking control.

### CROSS-REFERENCE TO RELATED APPLICATIONS

This application is a Continuation of PCT International Application No. PCT/JP2017/036252 filed on Oct. 5, 2017, which claims priority under 35 U.S.C. § 119(a) to Japanese Patent Application No. 2016-242628 filed on Dec. 14, 2016. Each of the above application(s) is hereby expressly incorporated by reference, in its entirety, into the present application.

### BACKGROUND OF THE INVENTION

### 1. Field of the Invention

The present invention relates to a projection display device, a method for controlling the projection display device, and a program for controlling the projection display device.

### 2. Description of the Related Art

A head-up display (HUD) for a vehicle has been known (see JP2009-227245A). In the HUD, a windshield of a vehicle or a combiner disposed in front of the windshield is used as a screen, and light is projected onto the screen to display an image. Examples of the vehicle include an automobile, a train, a ship, a construction machine, an aircraft, and an agricultural machine. The HUD enables a driver to visually recognize an image based on the light projected from the HUD as a real image on the screen or as a virtual image ahead of the screen.

JP2014-129676A and JP2009-173195A disclose techniques of improving operation efficiency at the time of construction work by using various construction machines by which an operator of a hydraulic shovel, a wheel loader, a bulldozer, a motor grader, or the like can visually recognize a working machine by using the HUD.

### SUMMARY OF THE INVENTION

Some construction machines, agricultural machines, or the like having a working machine are provided with an undetachable structure such as a handrail or a fence ahead of a front windshield of a driver's seat. In such a vehicle, in a case where an HUD is used to perform control such that the display position of information is changed in accordance with the movement of the working machine, there is a possibility the structure ahead of the front windshield and information to be displayed overlap with each other and that an operator has difficulty in visually recognizing the information.

JP2009-227245A describes a technique of improving visibility of information by shifting the display position of information in a case where an unnecessary object, which is ahead of the front windshield and is not wished to be visually recognized by a driver, and the information to be displayed overlap with each other. By using this technique, also in a construction machine or an agricultural machine having a working machine, it is possible to prevent the structure and the information to be displayed from overlapping with each other.

However, in a case where the display position of information is frequently changed regardless of the position of the working machine, the operator's line of sight also moves frequently. Thus, there is a possibility that a workload is placed on the operator and the operation efficiency is decreased. In a case of a vehicle such as a construction machine or an agricultural machine having the working machine, the working machine moves frequently in a wide range, and thus, it is particularly important to take measures against such an issue.

JP2014-129676A and JP2009-173195A describe changing the display position of information so as to track the movement of the working machine, but do not assume a case in which the structure ahead of the front windshield and a displayed image overlap with each other.

The present invention has been made in view of the above circumstances, and an object is to provide a projection display device that can improve the operation efficiency of a vehicle having a working machine, a method for controlling the projection display device, and a program for controlling the projection display device.

A projection display device according to the present invention is a projection display device to be built in a vehicle having a movable working machine, a main body part, and a structure, the working machine being attached to the main body part, the main body part having a driver's cabin, the structure being fixed ahead of the driver's cabin. The projection display device includes: a projection display unit, an overlapping area detecting unit, and a display control unit. The projection display unit includes a light modulation unit that, on the basis of image information to be input, spatially modulates light emitted from a light source. The projection display unit projects image light, obtained through spatial modulation by the light modulation unit, onto a projection surface built in the driver's cabin to display a virtual image based on the image light. The overlapping area detecting unit detects a first overlapping area of the projection surface and the working machine observed from a driver's seat in the driver's cabin. The display control unit controls the image information to be input to the light modulation unit and controls the virtual image that is to be displayed by the projection display unit. In a state where a distance between a second overlapping area and the first overlapping area exceeds a threshold, the second overlapping area being an overlapping area of the projection surface and the structure observed from the driver's seat, the display control unit performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control unit selects and performs either first control or the tracking control on the basis of a content of the operation support information. The first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

A method for controlling a projection display device according to the present invention is a method for controlling a projection display device, the projection display device being to be built in a vehicle having a movable working machine, a main body part, and a structure, the working machine being attached to the main body part, the main body part having a driver's cabin, the structure being fixed ahead of the driver's cabin. The projection display device includes a light modulation unit that, on the basis of image information to be input, spatially modulates light emitted from a light source, and a projection display unit that projects image light, obtained through spatial modulation by the light modulation unit, onto a projection surface built in the driver's cabin to display a virtual image based on the image light. The method includes: an overlapping area detection step and a display control step. The overlapping area detecting step detects a first overlapping area of the projection surface and the working machine observed from a driver's seat in the driver's cabin. The display control step controls the image information to be input to the light modulation unit and for controlling the virtual image that is to be displayed by the projection display unit. In a state where a distance between a second overlapping area and the first overlapping area exceeds a threshold, the second overlapping area being an overlapping area of the projection surface and the structure observed from the driver's seat, the display control step performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control step selects and performs either first control or the tracking control on the basis of a content of the operation support information. The first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

A program for controlling a projection display device according to the present invention is a program for controlling a projection display device, the projection display device being to be built in a vehicle having a movable working machine, a main body part, and a structure, the working machine being attached to the main body part, the main body part having a driver's cabin, the structure being fixed ahead of the driver's cabin. The projection display device includes a light modulation unit that, on the basis of image information to be input, spatially modulates light emitted from a light source, and a projection display unit that projects image light, obtained through spatial modulation by the light modulation unit, onto a projection surface built in the driver's cabin to display a virtual image based on the image light. The program is for causing a computer to execute: an overlapping area detection step and a display control step. The overlapping area detecting step detects a first overlapping area of the projection surface and the working machine observed from a driver's seat in the driver's cabin. The display control step controls the image information to be input to the light modulation unit and for controlling the virtual image that is to be displayed by the projection display unit. In a state where a distance between a second overlapping area and the first overlapping area exceeds a threshold, the second overlapping area being an overlapping area of the projection surface and the structure observed from the driver's seat, the display control step performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control step selects and performs either first control or the tracking control on the basis of a content of the operation support information. The first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

According to the present invention, it is possible to provide a projection display device that can improve the operation efficiency of a vehicle having a working machine, a method for controlling the projection display device, and a program for controlling the projection display device.

### BRIEF DESCRIPTION OF THE DRAWINGS

FIG. 1 is a schematic diagram illustrating a schematic configuration of a construction machine in which an HUD that is an embodiment of a projection display device according to the present invention is built;

FIG. 2 is a schematic diagram illustrating an internal configuration example of a driver's cabin in the construction machine 1 illustrated in FIG. 1;

FIG. 3 is a schematic diagram illustrating a state of a front windshield in a case where seen from a driver's seat in the driver's cabin in the construction machine illustrated in FIG. 1;

FIG. 4 is a schematic diagram illustrating an internal configuration of the HUD illustrated in FIGS. 1 and 2;

FIG. 5 is a functional block diagram of a system control unit illustrated in FIG. 4;

FIG. 6 is a diagram illustrating a projection area observed from the driver's seat (eye box);

FIG. 7 is a diagram illustrating the projection area observed from the driver's seat (eye box);

FIG. 8 is a diagram illustrating the projection area observed from the driver's seat (eye box);

FIG. 9 is a diagram illustrating the projection area observed from the driver's seat (eye box);

FIG. 10 is a diagram illustrating the projection area observed from the driver's seat (eye box);

FIG. 11 is a diagram illustrating the projection area observed from the driver's seat (eye box);

FIG. 12 is a diagram illustrating the projection area observed from the driver's seat (eye box);

FIG. 13 is a diagram illustrating the projection area observed from the driver's seat (eye box);

FIG. 14 is a diagram illustrating the projection area observed from the driver's seat (eye box);

FIG. 15 is a diagram illustrating the projection area observed from the driver's seat (eye box);

FIG. 16 is a diagram illustrating the projection area observed from the driver's seat (eye box);

FIG. 17 is a diagram illustrating the projection area observed from the driver's seat (eye box);

FIG. 18 is a diagram illustrating the projection area observed from the driver's seat (eye box);

FIG. 19 is a diagram illustrating the projection area observed from the driver's seat (eye box);

FIG. 20 is a diagram illustrating the projection area observed from the driver's seat (eye box); and

FIG. 21 is a flowchart for describing operations of the system control unit illustrated in FIG. 5.

### DESCRIPTION OF THE PREFERRED EMBODIMENTS

Now, an embodiment of the present invention will be described with reference to the drawings.

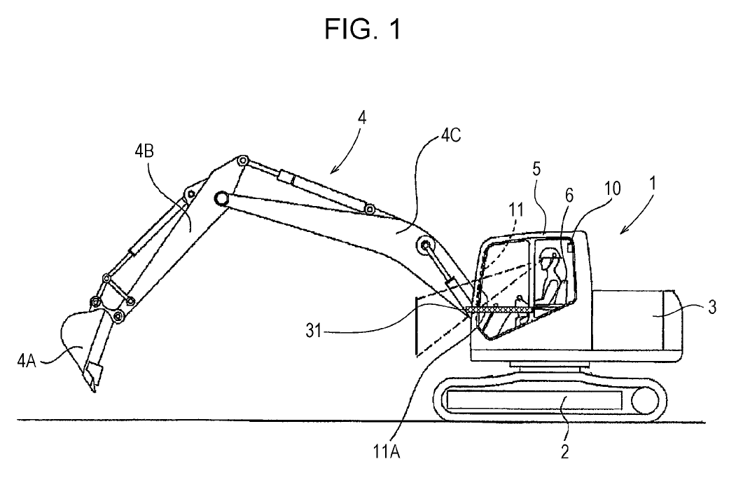

FIG. 1 is a schematic diagram illustrating a schematic configuration of a construction machine 1 in which an HUD 10 that is an embodiment of the projection display device according to the present invention is built.

The construction machine 1 is a hydraulic shovel and is composed of units such as an undercarriage 2, an upper rotatable body 3 that is supported by the undercarriage 2 in a rotatable manner, and a front operation unit 4 that is supported by the upper rotatable body 3. The undercarriage 2 and the upper rotatable body 3 constitute a main body part of the construction machine 1.

The undercarriage 2 includes a metal or rubber crawler for traveling on a public road or in a construction site.

The upper rotatable body 3 includes a driver's cabin 5 and a structure (e.g., a handrail or a fence) 31. In the driver's cabin 5, a control device for controlling the front operation unit 4 and a driver's seat 6 for an operator to be seated are set. The structure 31 is fixed to the driver's cabin 5 and is disposed ahead of a front windshield 11 of the driver's cabin 5.

The front operation unit 4 includes an arm 4C, a boom 4B, and a bucket 4A. The arm 4C is supported by the upper rotatable body 3 such that the arm 4C is movable in the gravity direction and a direction perpendicular to the gravity direction (vertical direction in the drawing and direction perpendicular to the drawing). The boom 4B is supported by the arm 4C such that the boom 4B is rotatable relative to the arm 4C. The bucket 4A is supported by the boom 4B such that the bucket 4A is rotatable relative to the boom 4B. The bucket 4A is a part that can directly contact a target such as the earth or an object to be carried and constitutes a working machine.

Note that instead of the bucket 4A, another working machine, such as a steel frame cutting machine, a concrete crushing machine, a grabbing machine, or a hitting breaker, may be attached to the boom 4B.

The bucket 4A is movable in the vertical direction of the drawing relative to the driver's cabin 5 via the arm 4C and the boom 4B. In addition, the bucket 4A is rotatable around axes that are the line-of-sight direction of the operator who is seated on the driver's seat 6 and a direction perpendicular to the gravity direction. In addition, the boom 4B is rotatable around an axis that is perpendicular to the drawing.

Although omitted from the illustration, a group of sensors such as an angular rate sensor and a three-axis acceleration sensor for detecting the posture of the front operation unit 4 is provided in the front operation unit 4.

The driver's cabin 5 is provided with the front windshield 11 ahead of the driver's seat 6, and a part of the front windshield 11 is a region processed to reflect image light, which will be described later. Furthermore, this region constitutes a projection area 11A as a projection surface onto which image light emitted from the HUD 10 is projected.

The HUD 10 is set within the driver's cabin 5 and displays a virtual image with image light projected onto the projection area 11A, which is a part of a region of the front windshield 11, so that the operator who is seated on the driver's seat 6 can visually recognize the virtual image ahead of the front windshield 11.

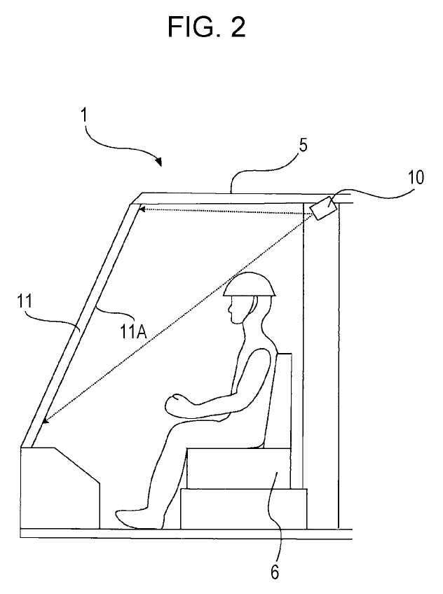

FIG. 2 is a schematic diagram illustrating an internal configuration example of the driver's cabin 5 in the construction machine 1 illustrated in FIG. 1.

As illustrated in FIG. 2, the HUD 10 is provided above and in the back of the operator in a state where the operator is seated on the driver's seat 6.

By seeing image light that has been projected onto and reflected on the projection area 11A of the front windshield 11, the operator of the construction machine 1 can visually recognize, as a virtual image, information such as an icon or characters for supporting the operation by using the construction machine 1. The projection area 11A has a function of reflecting the image light projected from the HUD 10 and transmitting light from the outdoor space (the outside) at the same time. Thus, the operator can visually recognize the virtual image based on the image light projected from the HUD 10, the virtual image overlapping with the outside scene.

Although the HUD 10 is built in the hydraulic shovel in the example in FIG. 1, the HUD 10 may be similarly built in any machine (e.g., a wheel loader, a bulldozer, a motor grader, or a forklift) in which an operator-controllable working machine is built ahead of the driver's seat 6.

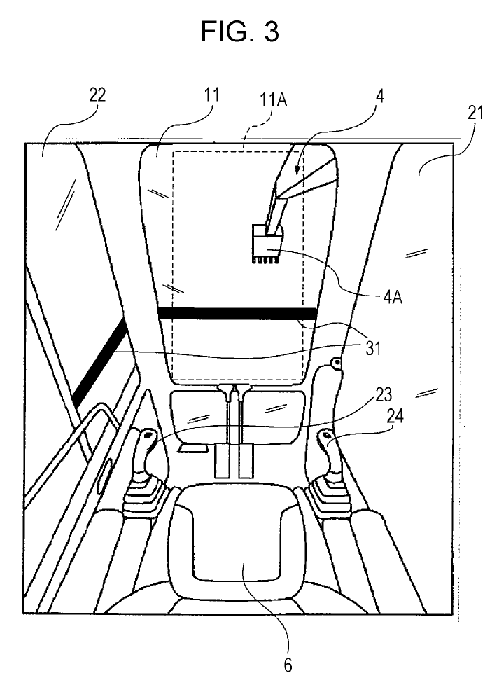

FIG. 3 is a schematic diagram illustrating a state of the front windshield 11 in a case where seen from the driver's seat 6 in the driver's cabin 5 in the construction machine 1 illustrated in FIG. 1.

The driver's cabin 5 is surrounded by the front windshield 11, a right-side windshield 21, and a left-side windshield 22. The driver's cabin 5 includes a left control lever 23, a right control lever 24, and the like around the driver's seat 6. The left control lever 23 is for controlling folding and stretching of the front operation unit 4 and rotation of the upper rotatable body 3. The right control lever 24 is for controlling digging and releasing of the bucket 4A in the front operation unit 4. Note that the operation functions assigned to the left control lever 23 and the right control lever 24 are examples and are not limited to the above examples.

The front windshield 11 has the projection area 11A onto which the image light emitted from the HUD 10 is projected, and the projection area 11A reflects the image light and transmits light from the outdoor space (the outside) at the same time. The structure 31 is provided ahead of the front windshield 11 and the left-side windshield 22, and the structure 31 overlaps with the projection area 11A in a case where seen from the driver's seat 6.

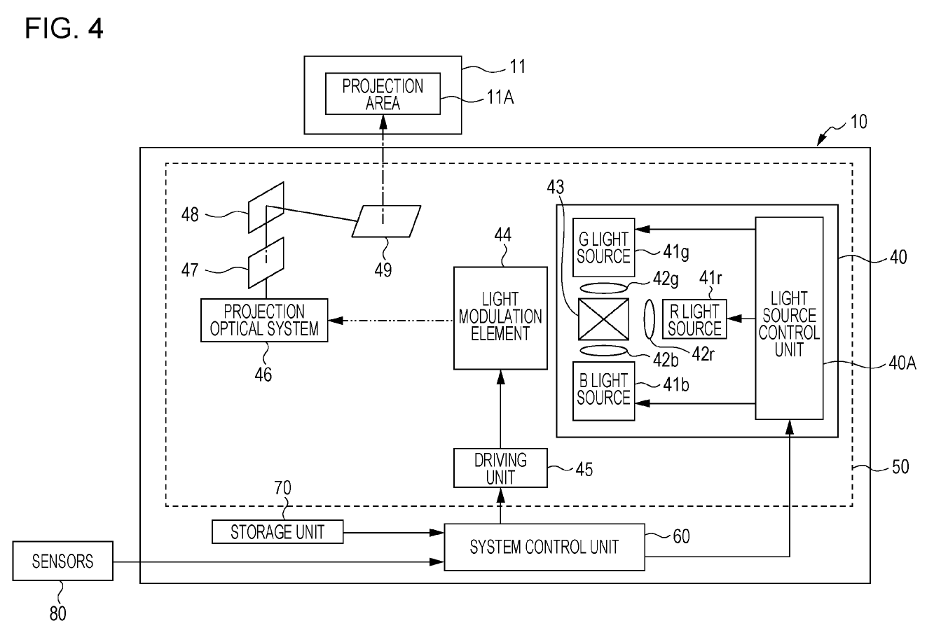

FIG. 4 is a schematic diagram illustrating an internal configuration of the HUD 10 illustrated in FIGS. 1 and 2.

The HUD 10 includes a light source unit 40, a light modulation element 44, a driving unit 45 that drives the light modulation element 44, a projection optical system 46, a diffusion plate 47, a reflective mirror 48, a magnifying glass 49, a system control unit 60 that controls the light source unit 40 and the driving unit 45, and a storage unit 70 that may be composed of a storage medium such as a flash memory.

The light source unit 40 includes a light source control unit 40A, an R light source 41r, a G light source 41g, a B light source 41b, a dichroic prism 43, a collimator lens 42r, a collimator lens 42g, and a collimator lens 42b. The R light source 41r is a red light source that emits red light, the G light source 41g is a green light source that emits green light, and the B light source 41b is a blue light source that emits blue light. The collimator lens 42r is provided between the R light source 41r and the dichroic prism 43, the collimator lens 42g is provided between the G light source 41g and the dichroic prism 43, and the collimator lens 42b is provided between the B light source 41b and the dichroic prism 43.

The dichroic prism 43 is an optical member for guiding light emitted from each of the R light source 41r, the G light source 41g, and the B light source 41b to the same optical path. That is, the dichroic prism 43 transmits red light collimated by the collimator lens 42r and emits the red light to the light modulation element 44. In addition, the dichroic prism 43 reflects green light collimated by the collimator lens 42g and emits the green light to the light modulation element 44. Furthermore, the dichroic prism 43 reflects blue light collimated by the collimator lens 42b and emits the blue light to the light modulation element 44. The optical member having such a function is not limited to the dichroic prism. For example, a cross dichroic mirror may also be used.

For each of the R light source 41r, the G light source 41g, and the B light source 41b, a light emitting element such as a laser or a light emitting diode (LED) is used. The R light source 41r, the G light source 41g, and the B light source 41b constitute a light source of the HUD 10. Although the light source of the HUD 10 includes three light sources, which are the R light source 41r, the G light source 41g, and the B light source 41b, in this embodiment, the number of light sources may be one, two, or four or more.

The light source control unit 40A sets the light emission amount of each of the R light source 41r, the G light source 41g, and the B light source 41b to a predetermined light emission amount pattern, and performs control so as to cause the R light source 41r, the G light source 41g, and the B light source 41b to sequentially emit light in accordance with the light emission amount pattern.

The light modulation element 44 spatially modulates the light emitted from the dichroic prism 43 on the basis of image information and emits the spatially modulated light (red image light, blue image light, and green image light) to the projection optical system 46.

As the light modulation element 44, for example, a liquid crystal on silicon (LCOS), a digital micromirror device (DMD), a micro electro mechanical systems (MEMS) element, a liquid crystal display element, or the like can be used.

On the basis of image information that is input from the system control unit 60, the driving unit 45 drives the light modulation element 44 to cause light (red image light, blue image light, and green image light) in accordance with image information to be emitted from the light modulation element 44 to the projection optical system 46.

The light modulation element 44 and the driving unit 45 constitute a light modulation unit of the HUD 10.

The projection optical system 46 is an optical system for projecting the light emitted from the light modulation element 44 onto the diffusion plate 47. This optical system is not limited to a lens, and a scanner can also be used. For example, light emitted from a scanner may be diffused by the diffusion plate 47 to form a plane light source.

The reflective mirror 48 reflects the light diffused by the diffusion plate 47 toward the magnifying glass 49.

The magnifying glass 49 enlarges and projects an image based on the light reflected on the reflective mirror 48 onto the projection area 11A.

The light source unit 40, the light modulation element 44, the driving unit 45, the projection optical system 46, the diffusion plate 47, the reflective mirror 48, and the magnifying glass 49 constitute a projection display unit 50. The projection display unit 50 spatially modulates light emitted from the R light source 41r, the G light source 41g, and the B light source 41b on the basis of image information that is input from the system control unit 60 and projects the spatially modulated image light onto the projection area 11A to display a virtual image based on the image light. The projection area 11A constitutes a display area in which the virtual image can be displayed by the projection display unit 50.

The system control unit 60 controls the light source control unit 40A and the driving unit 45 so as to cause image light based on image information to be emitted to the diffusion plate 47 through the projection optical system 46.

The diffusion plate 47, the reflective mirror 48, and the magnifying glass 49 illustrated in FIG. 4 are optically designed such that an image based on the image light projected onto the projection area 11A can be visually recognized as a virtual image at a position ahead of the front windshield 11.

The system control unit 60 is mainly composed of a processor and includes a read only memory (ROM) in which a program for executing the processor or the like is stored, a random access memory (RAM) as a work memory, and the like.

The storage unit 70 stores a plurality of pieces of operation support information. The operation support information is information for supporting efficient progress of the operation by being displayed in the vicinity of the bucket 4A, which is often observed by the operator during the operation.

The operation support information is, for example, characters or an arrow indicating the digging direction of the bucket 4A, characters or a scale indicating the digging amount (xx m), warming information for calling for attention, or the like.

Sensors 80 illustrated in FIG. 4 are a three-axis acceleration sensor, an angular rate sensor, and the like provided in the front operation unit 4. The acceleration information and angular rate information detected by the sensors 80 are input to the system control unit 60.

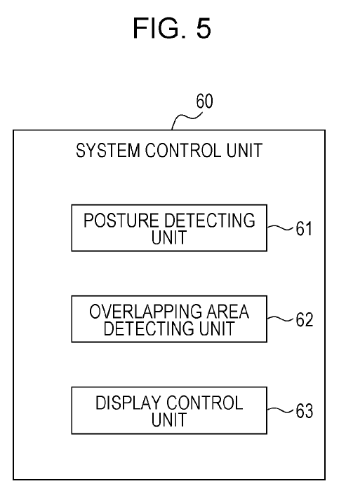

FIG. 5 is a functional block diagram of the system control unit 60 illustrated in FIG. 4.

The system control unit 60 includes a posture detecting unit 61, an overlapping area detecting unit 62, and a display control unit 63. The posture detecting unit 61, the overlapping area detecting unit 62, and the display control unit 63 are functional blocks formed by the processor of the system control unit 60 executing programs including a control program stored in the ROM.

On the basis of the acceleration information and angular rate information that are input from the sensors 80, the posture detecting unit 61 detects the posture of the bucket 4A determined on the basis of the position of the bucket 4A in the vertical direction and the distance to the bucket 4A from the driver's cabin 5.

The overlapping area detecting unit 62 detects a first overlapping area of the projection area 11A and the bucket 4A observed from the driver's seat 6.

In the HUD 10, an eye box is set in advance in a space above the driver's seat 6. As long as the operator's eyes are located in the eye box, the operator can visually recognize the virtual image displayed by the projection display unit 50.

In a case where the projection area 11A is observed from the eye box, if the posture of the bucket 4A is known, the first overlapping area of the projection area 11A and the bucket 4A observed from the driver's seat 6 can be detected because the position of the projection area 11A is fixed.

For example, a table is stored in the storage unit 70. In the table, all possible postures of the bucket 4A and information of the first overlapping area in the projection area 11A are associated with each other. In addition, the overlapping area detecting unit 62 detects the first overlapping area on the basis of the posture of the bucket 4A detected by the posture detecting unit 61 and the table.

Note that the first overlapping area may alternatively be detected by analyzing an image obtained by capturing an image of the projection area 11A by using an imaging device (e.g., an imaging device attached to the operator's helmet) in the vicinity of the eye box.

The display control unit 63 controls the image information to be input to the driving unit 45 and controls the virtual image to be displayed by the projection display unit 50. The display control unit 63 adds the operation support information read out from the storage unit 70 to the image information, thereby causing the projection display unit 50 to display a virtual image based on the operation support information.

The distance between a second overlapping area and the first overlapping area detected by the overlapping area detecting unit 62, the second overlapping area being an overlapping area of the projection area 11A and the structure 31 observed from the driver's seat 6, is set as a distance L. In a state where the distance L exceeds a threshold th, the display control unit 63 performs tracking control in which the projection display unit 50 is caused to display the operation support information while retaining a predetermined positional relationship with the first overlapping area. In a state where the distance L is less than or equal to the threshold th, the display control unit 63 selects and performs either first control or the tracking control on the basis of the content of the operation support information that is being displayed.

The distance L between the first overlapping area and the second overlapping area is a distance connecting the centers of the two areas in directions in which the bucket 4A is movable (gravity direction and inverse direction thereof).

The first control refers to control in which the retaining of the above positional relationship is cancelled and the operation support information is displayed at a position that avoids the second overlapping area or control in which the above positional relationship is retained and the display size of the operation support information is made greater than the display size in a state where the above distance L exceeds the threshold th.

The position of the structure 31 is fixed, the position of the projection area 11A is also fixed, and the position of the eye box is also determined. Thus, information of the second overlapping area can be stored in advance in the storage unit 70.

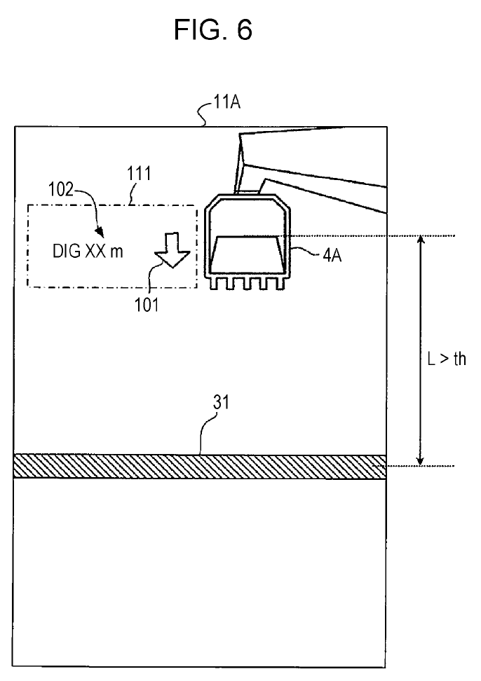

Next, specific examples of the tracking control and the first control performed by the system control unit 60 will be described. FIGS. 6 to 20 are diagrams illustrating the projection area 11A observed from the driver's seat 6.

FIG. 6 illustrates an example of observing a virtual image 101 and a virtual image 102 based on the operation support information from the eye box by using image light projected onto the projection area 11A.

In the example in FIG. 6, the bucket 4A and the structure 31 are observed together through the projection area 11A from the eye box. In FIGS. 6 to 20, the outline of the bucket 4A represents the first overlapping area, and the outline of the structure 31 represents the second overlapping area.

With an arrow, the virtual image 101 instructs the operator to start digging. With characters, the virtual image 102 instructs the operator to start digging (“dig xx m” in the example in FIG. 6).

In the case of the example in FIG. 6, the distance L between the first overlapping area and the second overlapping area exceeds the threshold th. Thus, the display control unit 63 performs the tracking control in which the virtual image 101 and the virtual image 102 are displayed in the predetermined positional relationship with the first overlapping area.

In the example in FIG. 6, the display control unit 63 causes the virtual image 101 and the virtual image 102 to be displayed in a display area 111 located at the left of the bucket 4A. In a case where the tracking control is performed, the position of the display area 111 is controlled to be constantly at a fixed position relative to the first overlapping area.

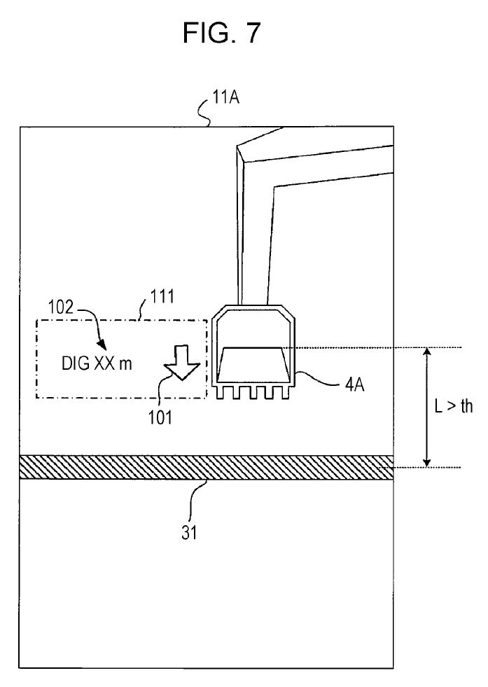

The operator of the construction machine 1 controls the left control lever 23 to move the bucket 4A downward from the state illustrated in FIG. 6. This process is illustrated in FIG. 7.

In the state in FIG. 7, the distance L between the first overlapping area and the second overlapping area remains to be in excess of the threshold th. Thus, as in the case in FIG. 6, the display control unit 63 performs the tracking control in which the virtual image 101 and the virtual image 102 are displayed in the display area 111 located at the left of the bucket 4A.

In this manner, in a state where the distance L between the first overlapping area and the second overlapping area is in excess of the threshold th, the display control unit 63 changes the display positions of the virtual image 101 and the virtual image 102 so as to track the movement of the first overlapping area (the bucket 4A), and retains the fixed positional relationship between the first overlapping area and the display positions of the virtual image 101 and the virtual image 102.

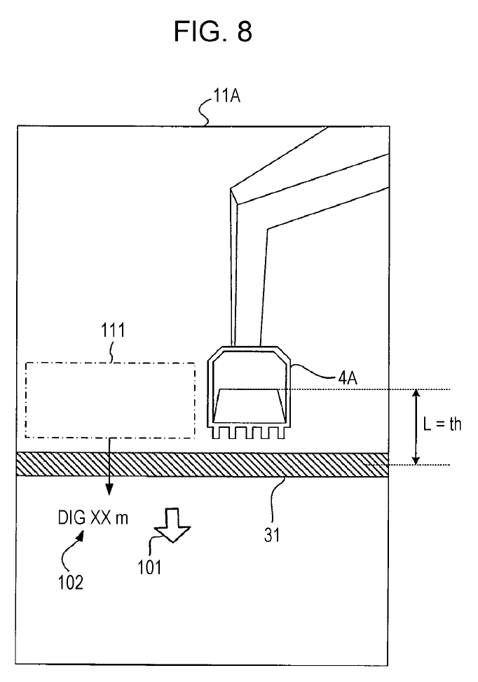

The operator of the construction machine 1 controls the left control lever 23 to move the bucket 4A further downward from the state illustrated in FIG. 7. This process is illustrated in FIG. 8.

In the state in FIG. 8, the distance L between the first overlapping area and the second overlapping area is changed from a state of being in excess of the threshold th to a state of being less than or equal to the threshold th.

FIG. 8 illustrates a case in which the display control unit 63 performs the first control. The display control unit 63 performs the first control in which the virtual image 101 and the virtual image 102 are not displayed in the display area 111 located at the left of the first overlapping area, and the virtual image 101 and the virtual image 102 are displayed at positions that are in the direction of movement of the first overlapping area and that avoid the second overlapping area (positions below the structure 31 in FIG. 8).

Thus, in a case where the tracking control is switched to the first control, the virtual images 101 and 102 that have been displayed near the bucket 4A as in FIGS. 6 and 7 jump across the structure 31 to a position away from the bucket 4A as illustrated in FIG. 8.

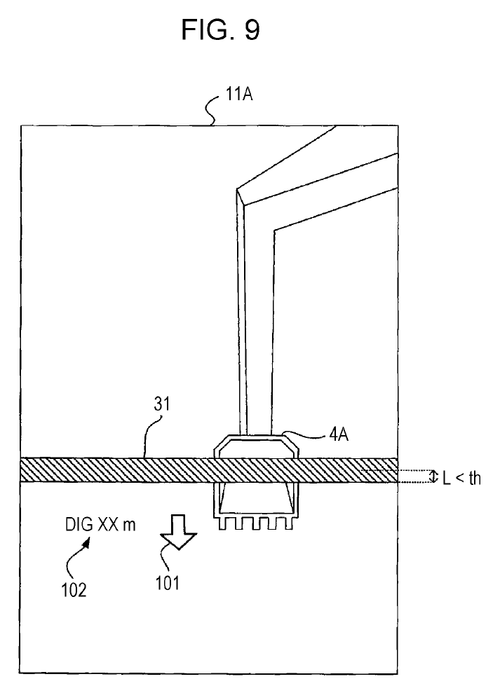

The operator of the construction machine 1 controls the left control lever 23 to move the bucket 4A further downward from the state illustrated in FIG. 8. This process is illustrated in FIG. 9.

In the state in FIG. 9, the distance L remains to be less than or equal to the threshold th. Thus, the display control unit 63 continuously performs the first control in which the display positions of the virtual image 101 and the virtual image 102 are retained at the same positions as those in the state in FIG. 8.

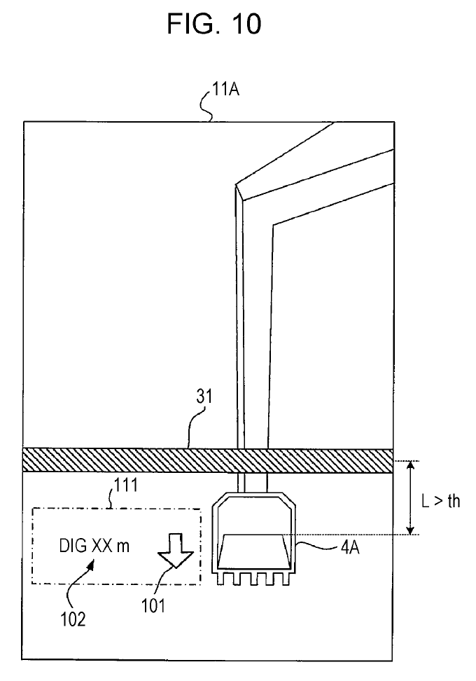

The operator of the construction machine 1 controls the left control lever 23 to move the bucket 4A further downward from the state illustrated in FIG. 9. This process is illustrated in FIG. 10.

In the state in FIG. 10, the distance L exceeds the threshold th. Thus, the display control unit 63 starts again the tracking control in which the virtual image 101 and the virtual image 102 are displayed in the display area 111 located at the left of the bucket 4A. Also, if the bucket 4A is moved further downward from the state illustrated in FIG. 10, the tracking control is performed, and the virtual image 101 and the virtual image 102 move in accordance with the bucket 4A.

According to the display examples in FIGS. 6 to 10, in a case where the distance L between the bucket 4A and the structure 31 observed from the driver's seat 6 exceeds the threshold th, the tracking control is performed in which the virtual images 101 and 102 are displayed so as to track the movement of the bucket 4A. Then, in a case where the distance L is changed from a state of exceeding the threshold th to a state of being less than or equal to the threshold th, the tracking control is switched to the first control in which the virtual images 101 and 102 are displayed at positions that avoid the structure 31 regardless of the position of the bucket 4A.

Thus, even if the bucket 4A jumps across the structure 31, it is possible to prevent the virtual images 101 and 102 from being shielded by the structure 31, and it is possible to improve the visibility of the virtual images and to increase the operation efficiency.

Next, modification examples of the first control performed by the display control unit 63 will be described.

First Modification

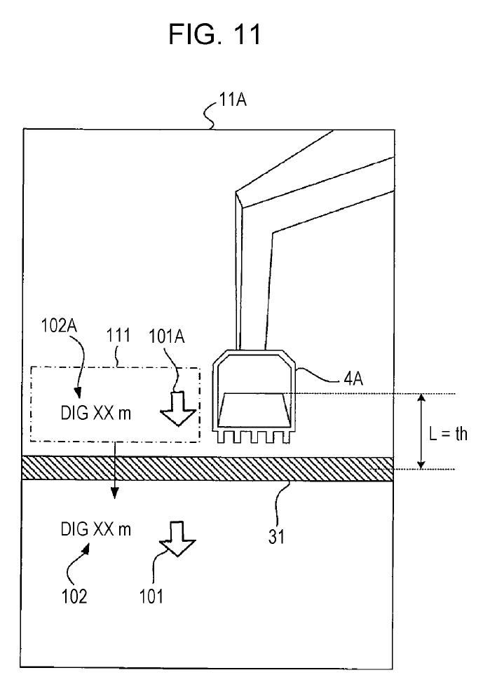

If the bucket 4A is moved downward from the state illustrated in FIG. 7 and the distance L between the first overlapping area and the second overlapping area reaches the threshold th, the display control unit 63 performs the first control in which, as illustrated in FIG. 11, the virtual image 101 and the virtual image 102 are not displayed in the display area 111 located at the left of the first overlapping area, and the virtual image 101 and the virtual image 102 are displayed at positions that are in the direction of movement of the first overlapping area and that avoid the second overlapping area (positions below the structure 31).

Furthermore, as illustrated in FIG. 11, the display control unit 63 causes a virtual image 101A that is a copy of the virtual image 101 and a virtual image 102A that is a copy of the virtual image 102 to be displayed in the display area 111 set in the last-time tracking control.

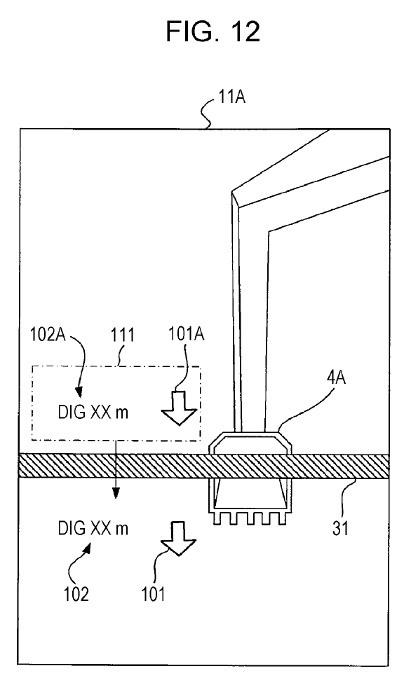

The operator of the construction machine 1 controls the left control lever 23 to move the bucket 4A further downward from the state illustrated in FIG. 11. This process is illustrated in FIG. 12.

In the state in FIG. 12, the distance L between the first overlapping area and the second overlapping area remains to be less than or equal to the threshold th. Thus, the display control unit 63 continuously performs the first control in which display of the virtual image 101, the virtual image 102, the virtual image 101A, and the virtual image 102A is retained in the state in FIG. 11.

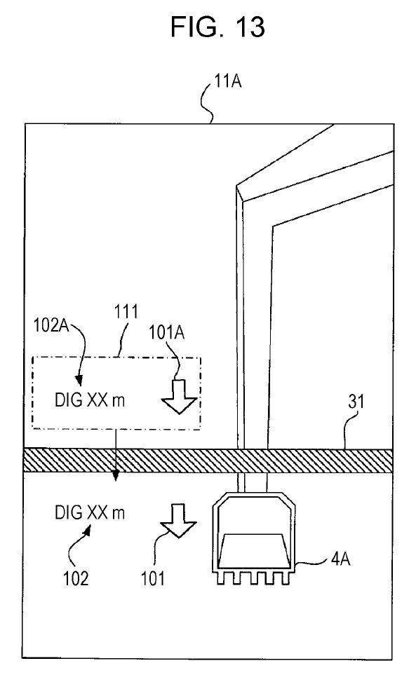

The operator of the construction machine 1 controls the left control lever 23 to move the bucket 4A further downward from the state illustrated in FIG. 12. This process is illustrated in FIG. 13.

In the state in FIG. 13, the distance L between the first overlapping area and the second overlapping area remains to be less than or equal to the threshold th. Thus, the display control unit 63 continuously performs the first control in which display of the virtual image 101, the virtual image 102, the virtual image 101A, and the virtual image 102A is retained in the state in FIG. 11. Subsequently, if the bucket 4A is moved further downward and the distance L exceeds the threshold th, the display control unit 63 deletes the virtual images 101A and 102A that have been displayed in the display area 111 to start the tracking control again.

According to the first control described in FIGS. 11 to 13, as long as the distance L is less than or equal to the threshold th, the virtual images 101 and 102 and the copies of the virtual images 101 and 102 are displayed at positions that do not overlap with the structure 31. This can improve the visibility of the operation support information and can increase the operation efficiency.

Second Modification

If the bucket 4A is moved downward from the state illustrated in FIG. 7 and the distance L between the first overlapping area and the second overlapping area reaches the threshold th, the display control unit 63 performs the first control in which the display positions of the virtual image 101 and the virtual image 102 are fixed in the display area 111 set in the last-time tracking control. Then, even if the bucket 4A is moved further downward, in a state where the distance L is less than or equal to the threshold th, the display control unit 63 does not change the display positions of the virtual image 101 and the virtual image 102.

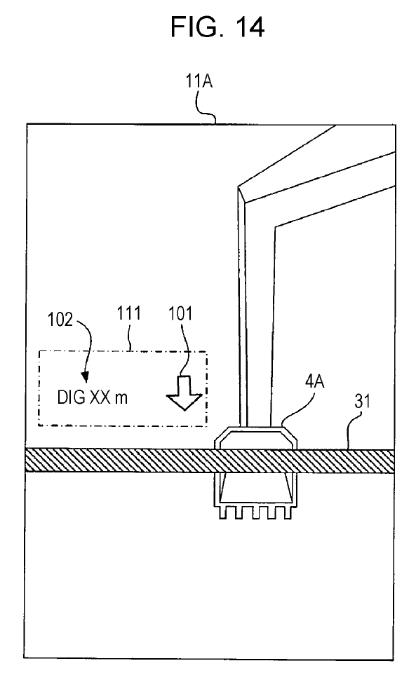

FIG. 14 illustrates a state in which the bucket 4A is moved downward from the state illustrated in FIG. 7 and the distance L becomes less than or equal to the threshold th. In this state, the virtual images 101 and 102 remain displayed in the display area 111 set immediately before the distance L has become equal to the threshold th.

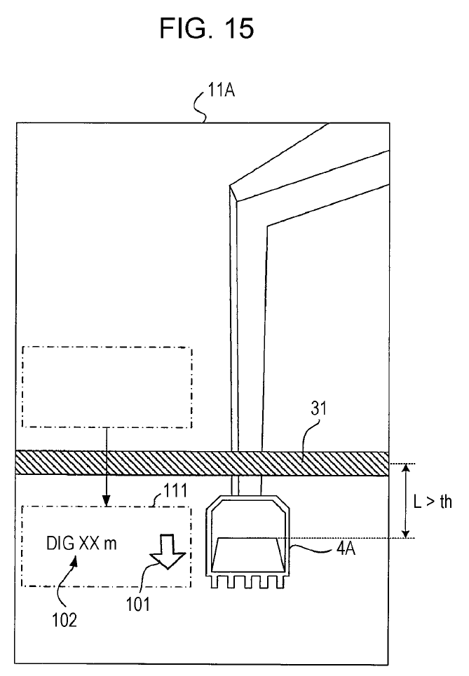

The operator of the construction machine 1 controls the left control lever 23 to move the bucket 4A further downward from the state illustrated in FIG. 14. This process is illustrated in FIG. 15.

In the state in FIG. 15, the distance L exceeds the threshold th. If the distance L exceeds the threshold th, the display control unit 63 switches the first control to the tracking control. Thus, as illustrated in FIG. 15, the virtual images 101 and 102 are moved to the display area 111 set at the left of the bucket 4A.

According to the first control described in FIGS. 14 and 15, as long as the distance L is less than or equal to the threshold th, the virtual images 101 and 102 are fixed at the display positions immediately before the distance L has become less than or equal to the threshold th, and thus, even if the bucket 4A overlaps with the structure 31, it is possible to prevent the virtual images 101 and 102 from being shielded by the structure 31. This can improve the visibility of the operation support information and can increase the operation efficiency.

Third Modification

If the bucket 4A is moved downward from the state illustrated in FIG. 7 and as long as the distance L between the first overlapping area and the second overlapping area is less than or equal to the threshold th, the display control unit 63 performs the first control in which the display sizes of the virtual image 101 and the virtual image 102 are made larger than the display sizes set in the last-time tracking control.

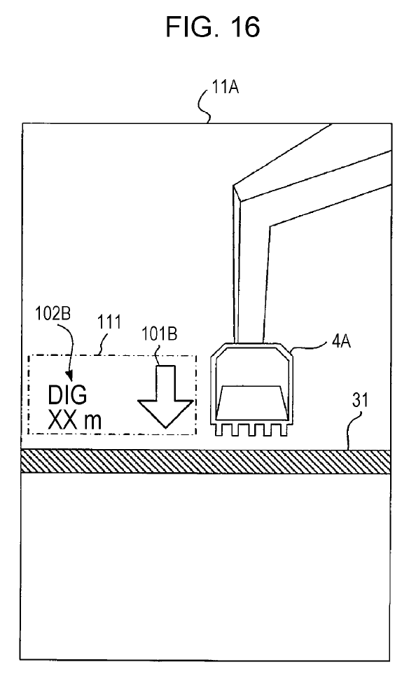

FIG. 16 illustrates a state in which the bucket 4A is moved downward from the state illustrated in FIG. 7 and the distance L becomes less than or equal to the threshold th. In this state, the display control unit 63 causes virtual images 101B and 102B to be displayed in the display area 111 set at a predetermined position relative to the first overlapping area. The virtual image 101B is an enlarged virtual image of the virtual image 101 illustrated in FIG. 7, and the virtual image 102B is an enlarged virtual image of the virtual image 102 illustrated in FIG. 7.

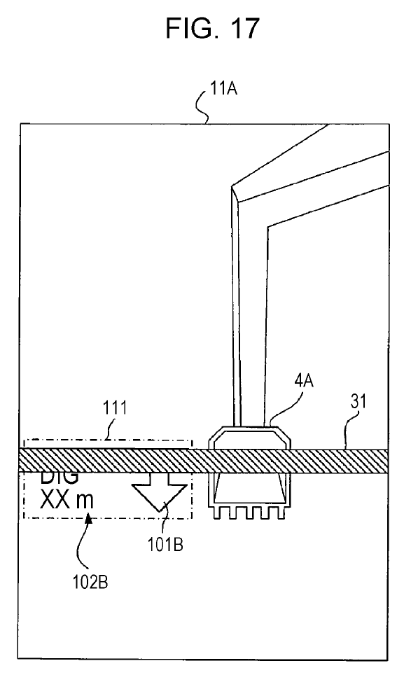

The operator of the construction machine 1 controls the left control lever 23 to move the bucket 4A further downward from the state illustrated in FIG. 16. This process is illustrated in FIG. 17.

In the state in FIG. 17, although the distance L between the first overlapping area and the second overlapping area is less than or equal to the threshold th, the display control unit 63 moves the virtual images 101B and 102B to the display area 111 set at a predetermined position relative to the first overlapping area. In the example in FIG. 17, a part of the virtual image 101B and a part of the virtual image 102B are shielded by the structure 31, but the virtual image 101B and the virtual image 102B are larger than the virtual image 101 and the virtual image 102, and thus, the contents thereof can briefly be understood.

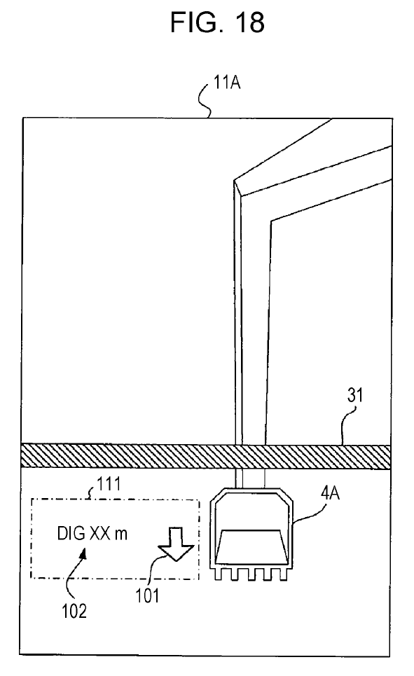

FIG. 18 illustrates a state in which the bucket 4A is moved further downward from the state illustrated in FIG. 17 and the distance L exceeds the threshold th. In this state, the display control unit 63 causes the virtual images 101 and 102 to be displayed in the display area 111 set at the predetermined position relative to the first overlapping area. That is, the display sizes of the virtual images based on the operation support information are changed to the original display sizes, and the tracking control is started again.

According to the first control described in FIGS. 16 to 18, if the distance L is less than or equal to the threshold th, a virtual image based on the operation support information is displayed at larger size than that in a case where the distance L exceeds the threshold th. Thus, even if the bucket 4A overlaps with the structure 31, it is possible to prevent a large part of the virtual image based on the operation support information from being shielded by the structure 31. This can improve the visibility of the operation support information and can increase the operation efficiency.

If the distance L becomes less than or equal to the threshold th, it is determined whether the display control unit 63 performs either the tracking control or the first control on the basis of the content of the operation support information displayed in the tracking control immediately before the distance L has become less than or equal to the threshold th. The content of the operation support information herein is, for example, a difference between the width of a virtual image based on the operation support information in the movement direction of the bucket 4A and the width of the second overlapping area (the structure 31) in the movement direction of the bucket 4A. Alternatively, the content of the operation support information is, for example, information indicating whether the virtual image based on the operation support information is a virtual image based on warning information.

In a case where the tracking control is performed, if the bucket 4A jumps across the structure 31, the virtual image based on the operation support information also jumps over the structure 31. However, in a case where the width of the virtual image based on the operation support information in the movement direction of the bucket 4A is sufficiently larger than the width of the second overlapping area (the structure 31) in the movement direction of the bucket 4A, even if the virtual image is shielded by the structure 31 due to the tracking control, the brief content of the operation support information indicated by the virtual image can be confirmed. For example, in a case where the width of the virtual image based on the operation support information in the movement direction of the bucket 4A is three times as large as the width of the second overlapping area (the structure 31) in the movement direction of the bucket 4A, the brief content of the operation support information indicated by the virtual image can be confirmed.

On the other hand, in a case where the difference between the width of the virtual image based on the operation support information in the movement direction of the bucket 4A and the width of the second overlapping area (the structure 31) in the movement direction of the bucket 4A is small, a period during which the virtual image is completely shielded by the structure 31 due to the tracking control may occur, or a period during which most of the virtual image is completely shielded by the structure 31 may occur. Thus, it becomes difficult to inform the operator of the operation support information indicated by the virtual image. For example, in a case where the width of the virtual image based on the operation support information in the movement direction of the bucket 4A is less than or equal to the width of the second overlapping area (the structure 31) in the movement direction of the bucket 4A, a period during which the virtual image is completely shielded by the structure 31 due to the tracking control occurs.

In addition, in a case where a virtual image based on warning information is displayed as the operation support information, a period during which the virtual image based on warning information is shielded by the structure 31 due to the tracking control may occur, and thus, it becomes difficult to inform the operator of the warning information indicated by the virtual image.

Accordingly, in a case where the distance L becomes less than or equal to the threshold th, if the width of the virtual image that is being displayed in the movement direction of the bucket 4A is greater than the width of the second overlapping area (the structure 31) in the movement direction of the bucket 4A by a width threshold or more, the display control unit 63 continues the tracking control. On the other hand, if the width of the virtual image that is being displayed in the movement direction of the bucket 4A is not greater than the width of the second overlapping area (the structure 31) in the movement direction of the bucket 4A by the width threshold or more, the display control unit 63 performs the first control.

In addition, in a case where the distance L becomes less than or equal to the threshold th, the display control unit 63 continues the tracking control if the virtual image based on the warning information is not displayed, and performs the first control if the virtual image based on the warning information is displayed.

The virtual image 101 and the virtual image 102 illustrated in FIG. 6 and the like are each illustrated as an example in which the width thereof in the movement direction of the bucket 4A is not greater than the width of the second overlapping area (the structure 31) in the movement direction of the bucket 4A by the width threshold or more.

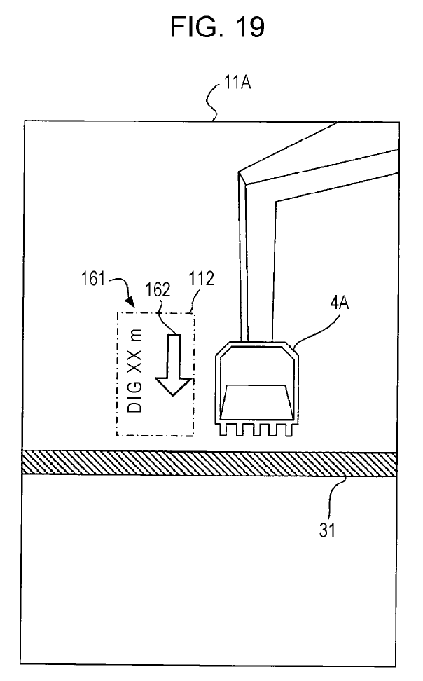

FIG. 19 illustrates a display example of virtual images whose width in the movement direction of the bucket 4A is greater than the width of the second overlapping area (the structure 31) in the movement direction of the bucket 4A by the width threshold or more. In the example in FIG. 19, a virtual image 161 of characters “dig xx m” and a virtual image 162 of an arrow are displayed in a display area 112.

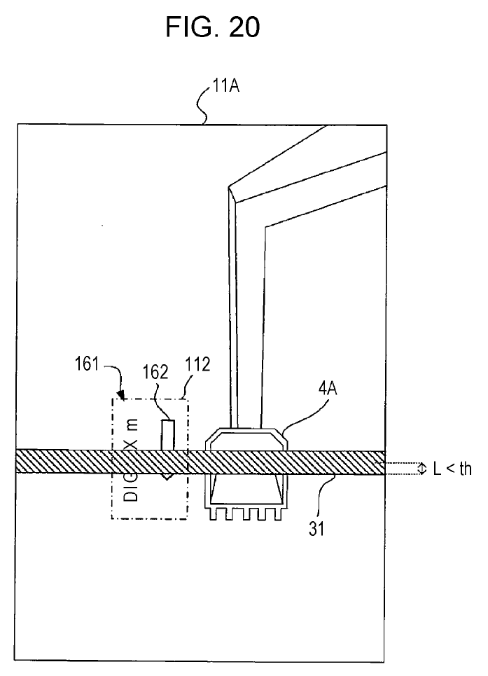

In a case where the virtual images 161 and 162 illustrated in FIG. 19 are displayed, regardless of the value of the distance L, the display control unit 63 performs the tracking control. FIG. 20 is a diagram illustrating a state where the bucket 4A is moved downward from the state illustrated in FIG. 19.

The display area 112 illustrated in FIG. 19 moves in accordance with the position of the bucket 4A in FIG. 20, and although a part of the virtual image 161 and a part of the virtual image 162 displayed in the display area 112 are shielded by the structure 31, the content thereof can briefly be understood.

For all virtual images based on the operation support information to be displayed in the display areas 111 and 112 set during the tracking control, the display control unit 63 compares the width thereof in the movement direction of the bucket 4A with the width of the second overlapping area. In a case where there is at least one virtual image whose width is less than the width of the second overlapping area or whose width is greater than the width of the second overlapping area but whose difference in width is small, the first control is preferably performed if the distance L becomes less than or equal to the threshold th.

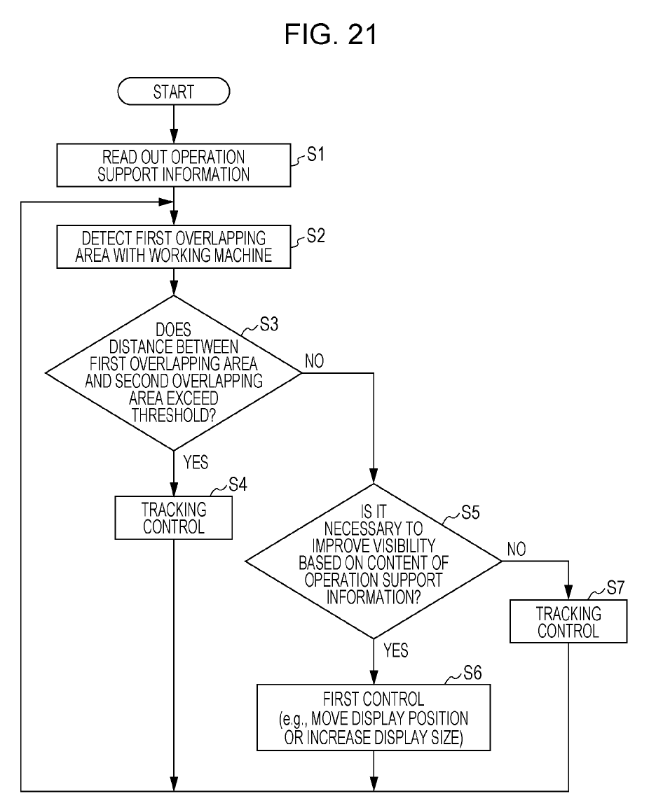

FIG. 21 is a flowchart for describing operations of the system control unit 60 illustrated in FIG. 5. Note that the process illustrated in FIG. 21 is repeatedly executed as long as the power of the HUD 10 is on.

First, the display control unit 63 reads out operation support information from the storage unit 70 (step S1).

Subsequently, on the basis of the posture of the bucket 4A detected by the posture detecting unit 61, the overlapping area detecting unit 62 detects the first overlapping area of the projection area 11A and the bucket 4A observed from the driver's seat 6 (step S2).

The display control unit 63 determines whether the distance L between the first overlapping area detected in step S2 and the second overlapping area of the projection area 11A and the structure 31 observed from the driver's seat 6 exceeds the threshold th (step S3), and if it is determined that the distance L exceeds the threshold th (step S3: YES), performs the tracking control (step S4) in which a virtual image based on the operation support information is displayed.

If the distance L is less than or equal to the threshold th (step S3: NO), on the basis of the content of the operation support information that has been read out from the storage unit 70 in step S1, the display control unit 63 determines whether it is necessary to improve the visibility of the operation support information (step S5).

If it is determined that it is necessary to improve the visibility on the basis of the content of the operation support information (step S5: YES), the display control unit 63 performs the first control (step S6).

If it is determined that it is not necessary to improve the visibility on the basis of the content of the operation support information (step S5: NO), the display control unit 63 performs the tracking control (step S7). After step S4, step S6, and step S7, the process returns to step S2.

As described above, with the HUD 10, if it can be determined that the bucket 4A approaches the structure 31 in a case where seen from the driver's seat 6 and the virtual image based on the operation support information may be shielded by the structure 31, on the basis of the content of the operation support information, it is determined whether the tracking control is to be continued or is to be switched to the first control, and necessary control is performed.

This can prevent the first control from being performed every time the bucket 4A approaches the structure 31. The less frequent first control can stabilize the operator's line of sight, and the operation efficiency can be increased.

As described above, the following matters are disclosed herein.

(1) A projection display device to be built in a vehicle having a movable working machine, a main body part, and a structure, the working machine being attached to the main body part, the main body part having a driver's cabin, the structure being fixed ahead of the driver's cabin, the projection display device including: a projection display unit that includes a light modulation unit that, on the basis of image information to be input, spatially modulates light emitted from a light source, and that projects image light, obtained through spatial modulation by the light modulation unit, onto a projection surface built in the driver's cabin to display a virtual image based on the image light; an overlapping area detecting unit that detects a first overlapping area of the projection surface and the working machine observed from a driver's seat in the driver's cabin; and a display control unit that controls the image information to be input to the light modulation unit and that controls the virtual image that is to be displayed by the projection display unit, in which, in a state where a distance between a second overlapping area and the first overlapping area exceeds a threshold, the second overlapping area being an overlapping area of the projection surface and the structure observed from the driver's seat, the display control unit performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control unit selects and performs either first control or the tracking control on the basis of a content of the operation support information, and in which the first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

(2) The projection display device according to (1), in which the first control is control in which the retaining of the positional relationship is cancelled and the virtual image based on the operation support information is displayed at the position that avoids the second overlapping area, and in which, in a case where the tracking control is switched to the first control, the display control unit causes the virtual image based on the operation support information to be displayed in a direction in which the first overlapping area is moving and causes the virtual image based on the operation support information to be displayed at a position that avoids the second overlapping area.

(3) The projection display device according to (1), in which the first control is control in which the retaining of the positional relationship is cancelled and the virtual image based on the operation support information is displayed at the position that avoids the second overlapping area, and in which, during the first control, the display control unit fixes a display position of the virtual image based on the operation support information at a position of the virtual image based on the operation support information immediately before the distance has become less than or equal to the threshold.

(4) The projection display device according to (1), in which the first control is control in which the retaining of the positional relationship is cancelled and the virtual image based on the operation support information is displayed at the position that avoids the second overlapping area, and in which, in a case where the tracking control is switched to the first control, the display control unit causes the virtual image based on the operation support information to be displayed in a direction in which the first overlapping area is moving, and during the first control, the display control unit causes a copy of the virtual image based on the operation support information to be displayed at a position where the virtual image has been displayed.

(5) A method for controlling a projection display device, the projection display device being to be built in a vehicle having a movable working machine, a main body part, and a structure, the working machine being attached to the main body part, the main body part having a driver's cabin, the structure being fixed ahead of the driver's cabin, the projection display device including a light modulation unit that, on the basis of image information to be input, spatially modulates light emitted from a light source, and a projection display unit that projects image light, obtained through spatial modulation by the light modulation unit, onto a projection surface built in the driver's cabin to display a virtual image based on the image light, the method including: an overlapping area detecting step of detecting a first overlapping area of the projection surface and the working machine observed from a driver's seat in the driver's cabin; and a display control step of controlling the image information to be input to the light modulation unit and for controlling the virtual image that is to be displayed by the projection display unit, in which, in a state where a distance between a second overlapping area and the first overlapping area exceeds a threshold, the second overlapping area being an overlapping area of the projection surface and the structure observed from the driver's seat, the display control step performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control step selects and performs either first control or the tracking control on the basis of a content of the operation support information, and in which the first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

(6) The method for controlling a projection display device according to (5), in which the first control is control in which the retaining of the positional relationship is cancelled and the virtual image based on the operation support information is displayed at the position that avoids the second overlapping area, and in which, in a case where the tracking control is switched to the first control, the display control step causes the virtual image based on the operation support information to be displayed in a direction in which the first overlapping area is moving and causes the virtual image based on the operation support information to be displayed at a position that avoids the second overlapping area.

(7) The method for controlling a projection display device according to (5), in which the first control is control in which the retaining of the positional relationship is cancelled and the virtual image based on the operation support information is displayed at the position that avoids the second overlapping area, and in which, during the first control, the display control step fixes a display position of the virtual image based on the operation support information at a position of the virtual image based on the operation support information immediately before the distance has become less than or equal to the threshold.

(8) The method for controlling a projection display device according to (5), in which the first control is control in which the retaining of the positional relationship is cancelled and the virtual image based on the operation support information is displayed at the position that avoids the second overlapping area, and in which, in a case where the tracking control is switched to the first control, the display control step causes the virtual image based on the operation support information to be displayed in a direction in which the first overlapping area is moving, and during the first control, the display control step causes a copy of the virtual image based on the operation support information to be displayed at a position where the virtual image has been displayed.

(9) A program for controlling a projection display device, the projection display device being to be built in a vehicle having a movable working machine, a main body part, and a structure, the working machine being attached to the main body part, the main body part having a driver's cabin, the structure being fixed ahead of the driver's cabin, the projection display device including a light modulation unit that, on the basis of image information to be input, spatially modulates light emitted from a light source, and a projection display unit that projects image light, obtained through spatial modulation by the light modulation unit, onto a projection surface built in the driver's cabin to display a virtual image based on the image light, the program for causing a computer to execute: an overlapping area detecting step of detecting a first overlapping area of the projection surface and the working machine observed from a driver's seat in the driver's cabin; and a display control step of controlling the image information to be input to the light modulation unit and for controlling the virtual image that is to be displayed by the projection display unit, in which, in a state where a distance between a second overlapping area and the first overlapping area exceeds a threshold, the second overlapping area being an overlapping area of the projection surface and the structure observed from the driver's seat, the display control step performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control step selects and performs either first control or the tracking control on the basis of a content of the operation support information, and in which the first control is control in which the retaining of the positional relationship is cancelled and the virtual image based on the operation support information is displayed at a position that avoids the second overlapping area or control in which the positional relationship is retained and a display size of the virtual image based on the operation support information is made greater than a display size of the virtual image based on the operation support information in a state where the distance exceeds the threshold.

According to the present invention, it is possible to increase the operation efficiency of a vehicle having a working machine.

### REFERENCE SIGNS LIST

1 construction machine
2 undercarriage
3 upper rotatable body
4 front operation unit
4A bucket
4B boom
4C arm
5 driver's cabin
6 driver's seat
10 HUD
11 front windshield
11A projection area
21 right-side windshield
22 left-side windshield
23 left control lever
24 right control lever
31 structure
40 light source unit
40A light source control unit
41r R light source
41g G light source
41b B light source
42r, 42g, 42b collimator lens
43 dichroic prism
44 light modulation element
45 driving unit
46 projection optical system
47 diffusion plate
48 reflective mirror
49 magnifying glass
50 projection display unit
60 system control unit
61 posture detecting unit
62 overlapping area detecting unit
63 display control unit
70 storage unit
80 sensors
111, 112 display area of virtual image during tracking control
101, 102 virtual image based on operation support information
101A, 102A virtual image based on operation support information
101B, 102B virtual image based on operation support information
161, 162 virtual image based on operation support information

What is claimed is:

1. A projection display device to be built in a vehicle having a movable working machine, a main body part, and a structure, the working machine being attached to the main body part, the main body part having a driver's cabin, the structure being fixed ahead of the driver's cabin, the projection display device comprising:
a projection display unit that includes a light modulation unit that, on the basis of image information to be input, spatially modulates light emitted from a light source, and that projects image light, obtained through spatial modulation by the light modulation unit, onto a projection surface built in the driver's cabin to display a virtual image based on the image light;
an overlapping area detecting unit that detects a first overlapping area of the projection surface and the working machine observed from a driver's seat in the driver's cabin; and
a display control unit that controls the image information to be input to the light modulation unit and that controls the virtual image that is to be displayed by the projection display unit,
wherein, in a state where a distance between a second overlapping area and the first overlapping area exceeds a threshold, the second overlapping area being an overlapping area of the projection surface and the structure observed from the driver's seat, the display control unit performs tracking control in which the projection display unit is caused to display a virtual image based on operation support information while retaining a predetermined positional relationship with the first overlapping area, and in a case where the distance is changed from a state of exceeding the threshold to a state of being less than or equal to the threshold, the display control unit selects and performs either first control or the tracking control on the basis of a content of the operation support information, and
wherein the first control is control in which the retaining of the positional relationship is cancelled and the virtual image based on the operation support information is displayed at a position that avoids the second overlapping area or control in which the retaining of the positional relationship is continued and a display size of the virtual image based on the operation support information is made greater than a display size of the virtual image based on the operation support information in a state where the distance exceeds the threshold.

2. The projection display device according to claim 1,
wherein the first control is control in which the retaining of the positional relationship is cancelled and the virtual image based on the operation support information is displayed at the position that avoids the second overlapping area, and
wherein, in a case where the tracking control is switched to the first control, the display control unit causes the virtual image based on the operation support information to be displayed in a direction in which the first overlapping area is moving and causes the virtual image based on the operation support information to be displayed at a position that avoids the second overlapping area.

3. The projection display device according to claim 1,
wherein the first control is control in which the retaining of the positional relationship is cancelled and the virtual image based on the operation support information is displayed at the position that avoids the second overlapping area, and
wherein, during the first control, the display control unit fixes a display position of the virtual image based on the operation support information at a position of the virtual image based on the operation support information immediately before the distance has become less than or equal to the threshold.

4. The projection display device according to claim 1,
wherein the first control is control in which the retaining of the positional relationship is cancelled and the virtual image based on the operation support information is displayed at the position that avoids the second overlapping area, and
wherein, in a case where the tracking control is switched to the first control, the display control unit causes the virtual image based on the operation support information to be displayed in a direction in which the first overlapping area is moving, and during the first control, the display control unit causes a copy of the virtual image based on the operation support information to be displayed at a position where the virtual image has been displayed.

5. A method for controlling the projection display device according to claim 1, the projection display device being to be built in the vehicle having the movable working machine, the main body part, and the structure, the working machine being attached to the main body part, the main body part having the driver's cabin, the structure being fixed ahead of the driver's cabin,
the projection display device including the light modulation unit that, on the basis of image information to be input, spatially modulates light emitted from the light source, and the projection display unit that projects the image light, obtained through spatial modulation by the light modulation unit, onto the projection surface built in the driver's cabin to display the virtual image based on the image light, the method comprising:
an overlapping area detecting step of detecting the first overlapping area of the projection surface and the working machine observed from the driver's seat in the driver's cabin; and
a display control step of controlling the image information to be input to the light modulation unit and for controlling the virtual image that is to be displayed by the projection display unit,
wherein, in the state where the distance between the second overlapping area and the first overlapping area exceeds the threshold, the second overlapping area being the overlapping area of the projection surface and the structure observed from the driver's seat, the display control step performs tracking control in which the projection display unit is caused to display the virtual image based on the operation support information while retaining the predetermined positional relationship with the first overlapping area, and in a case where the distance is changed from the state of exceeding the threshold to the state of being less than or equal to the threshold, the display control step selects and performs either first control or the tracking control on the basis of the content of the operation support information, and
wherein the first control is control in which the retaining of the positional relationship is cancelled and the virtual image based on the operation support information is displayed at the position that avoids the second overlapping area or control in which the retaining of the positional relationship is continued and the display size of the virtual image based on the operation support information is made greater than the display size of the virtual image based on the operation support information in the state where the distance exceeds the threshold.

6. The method for controlling a projection display device according to claim 5,
wherein the first control is control in which the retaining of the positional relationship is cancelled and the virtual image based on the operation support information is displayed at the position that avoids the second overlapping area, and
wherein, in a case where the tracking control is switched to the first control, the display control step causes the virtual image based on the operation support information to be displayed in a direction in which the first overlapping area is moving and causes the virtual image based on the operation support information to be displayed at a position that avoids the second overlapping area.

7. The method for controlling a projection display device according to claim 5,
wherein the first control is control in which the retaining of the positional relationship is cancelled and the virtual image based on the operation support information is displayed at the position that avoids the second overlapping area, and
wherein, during the first control, the display control step fixes a display position of the virtual image based on the operation support information at a position of the virtual image based on the operation support information immediately before the distance has become less than or equal to the threshold.

8. The method for controlling a projection display device according to claim 5,
wherein the first control is control in which the retaining of the positional relationship is cancelled and the virtual image based on the operation support information is displayed at the position that avoids the second overlapping area, and
wherein, in a case where the tracking control is switched to the first control, the display control step causes the virtual image based on the operation support information to be displayed in a direction in which the first overlapping area is moving, and during the first control, the display control step causes a copy of the virtual image based on the operation support information to be displayed at a position where the virtual image has been displayed.

9. A non-transitory computer readable recording medium storing a program for controlling the projection display device according to claim 1, the projection display device being to be built in the vehicle having the movable working machine, the main body part, and the structure, the working machine being attached to the main body part, the main body part having the driver's cabin, the structure being fixed ahead of the driver's cabin,
the projection display device including the light modulation unit that, on the basis of image information to be input, spatially modulates light emitted from the light source, and the projection display unit that projects the image light, obtained through spatial modulation by the light modulation unit, onto the projection surface built in the driver's cabin to display the virtual image based on the image light, the program causing a computer to execute:
an overlapping area detecting step of detecting the first overlapping area of the projection surface and the working machine observed from the driver's seat in the driver's cabin; and
a display control step of controlling the image information to be input to the light modulation unit and for controlling the virtual image that is to be displayed by the projection display unit,
wherein, in the state where the distance between the second overlapping area and the first overlapping area exceeds the threshold, the second overlapping area being the overlapping area of the projection surface and the structure observed from the driver's seat, the display control step performs tracking control in which the projection display unit is caused to display the virtual image based on the operation support information while retaining the predetermined positional relationship with the first overlapping area, and in the case where the distance is changed from the state of exceeding the threshold to the state of being less than or equal to the threshold, the display control step selects and performs either first control or the tracking control on the basis of the content of the operation support information, and
wherein the first control is control in which the retaining of the positional relationship is cancelled and the virtual image based on the operation support information is displayed at the position that avoids the second overlapping area or control in which the positional relationship is retained and the display size of the virtual image based on the operation support information is made greater than the display size of the virtual image based on the operation support information in the state where the distance exceeds the threshold.
